(19) United States
(12) Patent Application Publication
(10) Pub. No.: US 2026/0075492 A1
(43) Pub. Date: Mar. 12, 2026

(54) PARALLEL HANDOVER WITH MULTIPLE TRANSMISSION AND RECEPTION CHAINS

(71) Applicant: QUALCOMM Incorporated, San Diego, CA (US)

(72) Inventors: Ming YANG, San Diego, CA (US); Kausik RAY CHAUDHURI, San Diego, CA (US); Juan MONTOJO, San Diego, CA (US)

(21) Appl. No.: 18/826,766

(22) Filed: Sep. 6, 2024

(51) Int. Cl. H04W 36/36; H04W 74/0833

(52) U.S. Cl. CPC H04W 36/362; H04W 74/0833

(57) ABSTRACT

Methods, systems, and devices for wireless communications are described. A user equipment (UE) may exchange a set of messages with a network entity to enable the UE to perform a parallel handover (PHO) procedure. The UE may transmit a capability message indicating that the UE supports the PHO procedure, during which the UE may be configured to communicate with both a source cell and a target cell associated with the PHO procedure simultaneously using a set of transmit and receive chains of the UE. The UE may transmit a second message indicating a respective quantity of transmit and receive chains corresponding to one or more transmission and reception points (TRPs) associated with the PHO procedure, one or more respective TRPs corresponding to the source cell and the target cell, or both. Then, the UE may receive a configuration message based on the capability message.

### FIELD OF TECHNOLOGY

The following relates to wireless communications, including parallel handover with multiple transmission and reception chains.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include transmitting a capability message indicating that the UE supports a parallel handover (PHO) procedure during which the UE is configured to communicate with both a source cell associated with the PHO procedure and a target cell associated with the PHO procedure using a set of multiple transmit and receive chains of the UE, transmitting UE preference information associated with the PHO procedure, the UE preference information indicating a respective quantity of transmit and receive chains corresponding to one or more transmission and reception points (TRPs) associated with the PHO procedure, one or more respective TRPs corresponding to one or more cells associated with the PHO procedure, or both, the one or more cells including one or both of the source cell and the target cell, and receiving, based on the capability message, a configuration message that indicates a configuration for the PHO procedure.

A UE for wireless communications is described. The UE may include one or more memories storing processor executable code, and one or more processors coupled with the one or more memories. The one or more processors may individually or collectively be operable to execute the code to cause the UE to transmit a capability message indicating that the UE supports a PHO procedure during which the UE is configured to communicate with both a source cell associated with the PHO procedure and a target cell associated with the PHO procedure using a set of multiple transmit and receive chains of the UE, transmit UE preference information associated with the PHO procedure, the UE preference information indicating a respective quantity of transmit and receive chains corresponding to one or more TRPs associated with the PHO procedure, one or more respective TRPs corresponding to one or more cells associated with the PHO procedure, or both, the one or more cells including one or both of the source cell and the target cell, and receive, based on the capability message, a configuration message that indicates a configuration for the PHO procedure.

Another UE for wireless communications is described. The UE may include means for transmitting a capability message indicating that the UE supports a PHO procedure during which the UE is configured to communicate with both a source cell associated with the PHO procedure and a target cell associated with the PHO procedure using a set of multiple transmit and receive chains of the UE, means for transmitting UE preference information associated with the PHO procedure, the UE preference information indicating a respective quantity of transmit and receive chains corresponding to one or more TRPs associated with the PHO procedure, one or more respective TRPs corresponding to one or more cells associated with the PHO procedure, or both, the one or more cells including one or both of the source cell and the target cell, and means for receiving, based on the capability message, a configuration message that indicates a configuration for the PHO procedure.

A non-transitory computer-readable medium storing code for wireless communications is described. The code may include instructions executable by one or more processors to transmit a capability message indicating that the UE supports a PHO procedure during which the UE is configured to communicate with both a source cell associated with the PHO procedure and a target cell associated with the PHO procedure using a set of multiple transmit and receive chains of the UE, transmit UE preference information associated with the PHO procedure, the UE preference information indicating a respective quantity of transmit and receive chains corresponding to one or more TRPs associated with the PHO procedure, one or more respective TRPs corresponding to one or more cells associated with the PHO procedure, or both, the one or more cells including one or both of the source cell and the target cell, and receive, based on the capability message, a configuration message that indicates a configuration for the PHO procedure.

Some examples of the method, UEs, and non-transitory computer-readable medium described herein may further include operations, features, means, or instructions for performing, while in communication with both the source cell and the target cell using the set of multiple transmit and receive chains, the PHO procedure in accordance with the configuration.

Some examples of the method, UEs, and non-transitory computer-readable medium described herein may further include operations, features, means, or instructions for receiving a layer 1 or layer 3 handover command associated with the PHO procedure, where performing the PHO procedure may be based on receiving the layer 1 or layer 3 handover command.

In some examples of the method, UEs, and non-transitory computer-readable medium described herein, the layer 1 or layer 3 handover command may be received via a medium access control-control element (MAC-CE), a downlink control information message, radio resource control (RRC) signaling, or any combination thereof.

In some examples of the method, UEs, and non-transitory computer-readable medium described herein, the configuration for the PHO procedure includes an indication of a condition associated with the PHO procedure and performing the PHO procedure may be based on the condition being met.

Some examples of the method, UEs, and non-transitory computer-readable medium described herein may further include operations, features, means, or instructions for communicating with the source cell on a first frequency via a first radio access technology (RAT) and communicating with the target cell on a second frequency via a second RAT, where the first frequency and the second frequency include a same frequency or different frequencies, and where the first RAT and the second RAT include a same RAT or different RATs.

Some examples of the method, UEs, and non-transitory computer-readable medium described herein may further include operations, features, means, or instructions for receiving first scheduling information that may be based on the capability message and the configuration for the PHO procedure, the first scheduling information indicating an uplink or downlink lower multiple-input, multiple-output (MIMO) layer and a corresponding modulation and coding scheme (MCS) associated with communicating with the source cell.

Some examples of the method, UEs, and non-transitory computer-readable medium described herein may further include operations, features, means, or instructions for communicating with the source cell using a first subset of the set of multiple transmit and receive chains and performing a set of one or more operations associated with the target cell using a second subset of the set of multiple transmit and receive chains, the second subset non-overlapping or overlapping with the first subset.

In some examples of the method, UEs, and non-transitory computer-readable medium described herein, the set of one or more operations includes a search associated with the target cell, a downlink synchronization procedure associated with the target cell, an uplink synchronization procedure associated with the target cell using a physical random access channel, or any combination thereof and the set of one or more operations may be performed using transmit and receive chains indicated by the configuration for the PHO procedure.

Some examples of the method, UEs, and non-transitory computer-readable medium described herein may further include operations, features, means, or instructions for performing, in accordance with the PHO procedure, a random access channel procedure to establish uplink synchronization with the target cell using transmit and receive chains indicated by the configuration for the PHO procedure.

Some examples of the method, UEs, and non-transitory computer-readable medium described herein may further include operations, features, means, or instructions for receiving first scheduling information from the source cell at a first time and receiving second scheduling information from the target cell at a second time, where the first time and the second time include a same time or different times.

Some examples of the method, UEs, and non-transitory computer-readable medium described herein may further include operations, features, means, or instructions for receiving second scheduling information that may be based on the capability message and the configuration for the PHO procedure, the second scheduling information indicating a second uplink or downlink lower MIMO layer and a corresponding second MCS associated with communicating with the target cell, where the second scheduling information may be received using transmit and receive chains indicated by the configuration for the PHO procedure.

Some examples of the method, UEs, and non-transitory computer-readable medium described herein may further include operations, features, means, or instructions for transmitting an uplink message that includes a first indication that the PHO procedure may be complete, a second indication of using the set of multiple transmit and receive chains to communicate with the target cell, a third indication of using a set of multiple TRPs to communicate with the target cell, a fourth indication of a received packet data convergence protocol sequence number, or any combination thereof.

In some examples of the method, UEs, and non-transitory computer-readable medium described herein, one or more indications or parameters of the uplink message may be indicated via a MAC-CE, via an acknowledgment carried on a physical uplink control channel, via an acknowledgment that indicates that a physical random access channel procedure may be complete, via RRC signaling, or any combination thereof.

Some examples of the method, UEs, and non-transitory computer-readable medium described herein may further include operations, features, means, or instructions for suspending communications with the source cell based on a completion of the PHO procedure and communicating, based on the completion of the PHO procedure, with the target cell using a full set of transmit and receive chains corresponding to the set of multiple transmit and receive chains.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports parallel handover (PHO) with multiple transmission and reception chains in accordance with one or more aspects of the present disclosure.

FIG. 2 shows an example of a wireless communications system that supports PHO with multiple transmission and reception chains in accordance with one or more aspects of the present disclosure.

FIG. 3 shows an example of a process flow that supports PHO with multiple transmission and reception chains in accordance with one or more aspects of the present disclosure.

FIGS. 4 and 5 show block diagrams of devices that support PHO with multiple transmission and reception chains in accordance with one or more aspects of the present disclosure.

FIG. 6 shows a block diagram of a communications manager that supports PHO with multiple transmission and reception chains in accordance with one or more aspects of the present disclosure.

FIG. 7 shows a diagram of a system including a device that supports PHO with multiple transmission and reception chains in accordance with one or more aspects of the present disclosure.

FIGS. 8 through 10 show flowcharts illustrating methods that support PHO with multiple transmission and reception chains in accordance with one or more aspects of the present disclosure.

### DETAILED DESCRIPTION

In some wireless communications systems, a user equipment (UE) may communicate using a user plane. However, the user plane may experience interruptions due to various factors. Accordingly, during mobility (e.g., when switching from communications with a source cell to communications with a target cell), the UE may fail to meet quality of service (QoS) targets related to time critical communications (TCC) services. The UE may support a dual active protocol stack (DAPS), but DAPS may be relatively complex for hardware of the UE. Further, the UE may be unable to transmit on more than one cell at a same time and may be unable to synchronize timing between the more than one cell. Thus, techniques herein relate to implementing an enhanced parallel handover (PHO) procedure such that a UE may support more reliable communications during mobility (e.g., during a handover from a source cell to a target cell).

A UE may exchange a set of messages with a network entity to enable the UE to perform a PHO procedure that enhances communication efficiency during a handover. The UE may transmit a capability message indicating that the UE supports the PHO procedure. During the PHO procedure, the UE may be configured to communicate with both a source cell associated with the PHO procedure and a target cell associated with the PHO procedure using a set of transmit and receive chains of the UE. The UE may transmit a second message that includes UE preference information associated with the PHO procedure. The UE preference information may indicate a set of quantities, such as a respective quantity of transmit and receive chains corresponding to one or more cells associated with the PHO procedure, one or more respective transmission and reception points corresponding to the one or more cells, a respective quantity of transmission and reception points corresponding to the one or more cells, or any combination thereof. Then, the UE may receive a configuration message based on the capability message and the UE preference information. The configuration message may indicate a configuration for the PHO procedure. The UE may perform the PHO procedure based on receiving a layer 1 or layer 3 command, based on a condition associated with the PHO procedure being met, or both.

Aspects of the disclosure are initially described in the context of wireless communications systems. Aspects of the disclosure are then described in the context of a process flow. Aspects of the disclosure are further illustrated by and described with reference to apparatus diagrams, system diagrams, and flowcharts that relate to PHO with multiple transmission and reception chains.

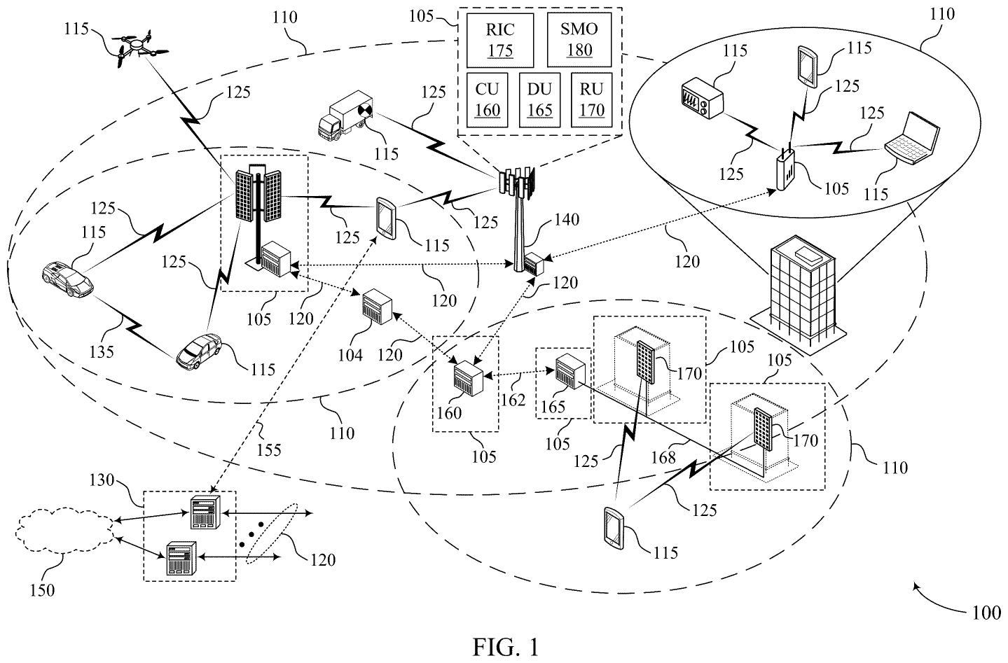

FIG. 1 shows an example of a wireless communications system 100 that supports PHO with multiple transmission and reception chains in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support PHO with multiple transmission and reception chains as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example, a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas.

Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some wireless communications systems, user plane interruption time may present issues for communication between one or more devices. During mobility procedures (e.g., during a handover), the one or more devices may support one or more TCC services and may target various QoS parameters related to the one or more TCC services. A given TCC use case category may be associated with different deployment options, use cases, and traffic patterns. For example, a remote control service (e.g., industry vehicles and car sharing) may be deployed according to a wide area, a local area, or a confined area. The remote control service may support uplink video feed, downlink and uplink control, or both. Devices in a remote control service may have seamless (e.g., optimized) connectivity across cell borders (e.g., handled with multi-subscription services). A real-time media service (e.g., augmented reality (AR), cloud gaming) may be deployed according to a wide area, a local area, or a confined area. The real-time media service may support downlink and uplink video feed, movement in uplink communications, downlink video, uplink control, or a combination thereof. Devices in a real-time media service may support increased quality of experience (QoE) when moving between cell borders (e.g., cell edges). A mobility automation service (e.g., automated guided vehicles (AGV) or mobile robots) may be deployed according to a local area or a confined area. The mobility automation service may support downlink and uplink control, uplink video, or the like. Devices in a mobility automation service may support equipment flexibility, moving automatically over a relatively wide area (e.g., between factory halls).

Some wireless communications systems may experience issues such as non-reliable handover, relatively long recovery after a handover failure, and relatively long data interruption during a handover. To mitigate the effects of such problems, some wireless communications system may improve handover reliability through conditional handover (CHO) procedures, may support relatively fast recovery in response to a handover failure, and may target lower data interruption times during handover through DAPS handover procedures.

Using DAPS techniques may result in one or more benefits. For example, DAPS techniques may result in relatively wide area deployments which use an L3 mobility mechanism (e.g., DAPS may use an L3 mechanism, providing relatively low user plane interruption time). DAPs techniques may also function in some established wide area deployments, and some TCC services may benefit from DAPS (e.g., depending on whether it may be more desirable to maintain high throughput or stricter latency requirements). However, some wireless communications system may experience drawbacks from applying DAPS techniques. For example, DAPs techniques may be relatively complex on a UE side and on a network entity side, and may not reuse one or more mechanisms (e.g., an existing multi-TRP mechanism), resulting in reduced compatibility (e.g., less synergy with other multi-TRP features). Further, a UE may be unable to transmit via more than one cell (e.g., a target cell and a source cell) at a same time (e.g., an uplink limitation). A UE may also use a relatively tight time synchronization between a set of cells, which may present issues when applying DAPS techniques. Further, during a DAPS handover, a UE may de-configure carrier aggregation (CA) and dual connectivity (DC) and may reduce MIMO layers. DAPS techniques may not be compatible with CHO, and may not be supported for one or more frequency ranges (e.g., FR2, due to analog beamforming).

Some wireless communications systems may support one or more mobility procedures or one or more handover procedures. For example, a layer 3 handover procedure (e.g., an L3 HO procedure) may begin in response to an RRC handover command, and may include a UE reconfiguration procedure, a downlink synchronization procedure, and an uplink synchronization procedure. A CHO procedure may begin in response to a CHO condition being met, and may include a UE reconfiguration procedure, a downlink synchronization procedure, an uplink synchronization procedure, and one or more delays. The layer 3 handover procedure may result in an interruption time similar to an interruption time of the CHO procedure. However, the CHO procedure may have a shorter or a longer interruption time depending a length of the one or more delays (e.g., depending on when data forwarding can begin after the delays).

In some cases, a lower-layer (e.g., Layer 1 or Layer 2) triggered mobility (LTM) procedure may result in a reduced interruption time. For example, to perform an LTM procedure, a UE may perform one or more pre-synchronization procedures to minimize an interruption time associated with UE reconfiguration. The UE may receive an LTM preparation message (e.g., an RRC reconfiguration message), and may exchange one or more messages with a network entity (e.g., an L1 measurement report, an early TCI state activation MAC-control element (MAC-CE), a PDCCH order message, and a physical random access channel (RACH) (PRACH) preamble) prior to receiving an LTM cell switch command via MAC-CE. After receiving the LTM cell switch command, the UE may perform the UE reconfiguration procedure, and may transmit a reconfiguration complete message.

In some wireless communications systems, when a UE receives a layer 1 or a layer 3 handover command (e.g., an L1 or an L3 handover command), or when the UE performs a CHO procedure, the UE may first suspend (e.g., stop) communications with a source cell. The UE may then perform a search and a downlink synchronization procedure. Next, the UE may wait for a PRACH occasion and may perform a PRACH procedure with a target cell to establish an uplink synchronization. During this period, a user plane (e.g., a data plane) may experience an interruption, which may diminish the user experience). In some cases, a UE may use the user plane to forward from a source cell to a target cell. Thus, in addition to an increase in data interruption time, this may also result in consumption of backhaul bandwidth. Although some devices may support DAPS techniques, these DAPS techniques may be unsupported by some systems (e.g., infrastructure vendors or UEs may not support DAPS due to complexity). Further, CHO may result in a higher data interruption during a handover procedure comparing with other handover procedures (e.g., in a live network).

The wireless communications system 100 may support a UE 115 to exchange a set of messages with a network entity 105 to enable the UE 115 to perform a PHO procedure that enhances communication efficiency during a handover (e.g., in a cell centric architecture with TRPs or in a TRP centric architecture). The UE 115 may transmit a capability message indicating that the UE 115 supports the PHO procedure. During the PHO procedure, the UE 115 may be configured to communicate with both a source cell (e.g., a first network entity 105) associated with the PHO procedure and a target cell (e.g., a second network entity 105) associated with the PHO procedure using a set of transmit and receive chains of the UE 115. The UE 115 may transmit a second message that includes preference information of the UE 115 associated with the PHO procedure. The preference information of the UE 115 may indicate a set of quantities, such as a respective quantity of transmit and receive chains corresponding to one or more cells associated with the PHO procedure, one or more respective transmission and reception points corresponding to the one or more cells, a respective quantity of transmission and reception points corresponding to the one or more cells, or any combination thereof. Then, the UE 115 may receive a configuration message based on the capability message and the preference information of the UE 115. The configuration message may indicate a configuration for the PHO procedure. The UE 115 may perform the PHO procedure based on receiving a layer 1 or layer 3 command, based on a condition associated with the PHO procedure being met, or both.

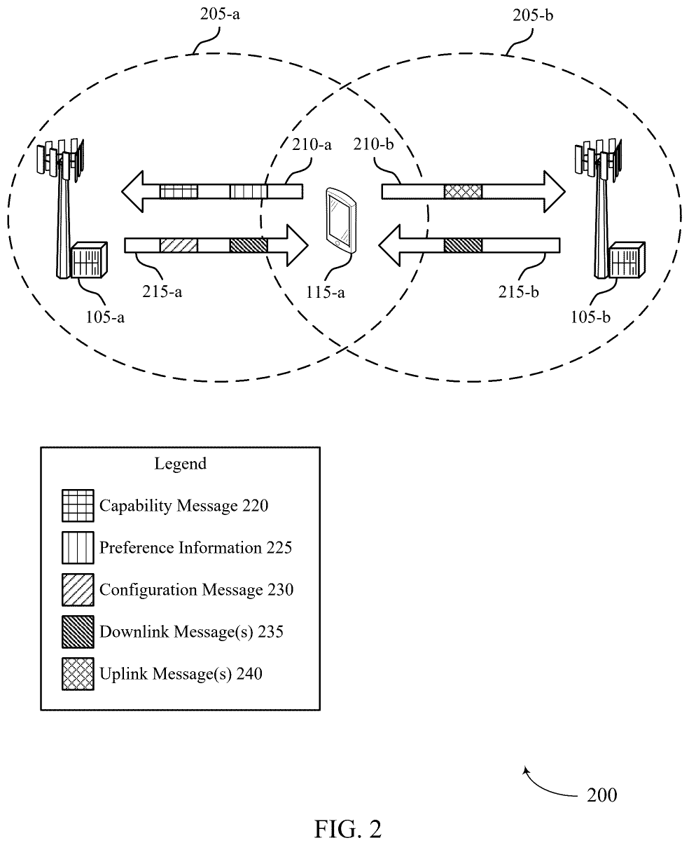

FIG. 2 shows an example of a wireless communications system 200 that supports PHO with multiple transmission and reception chains in accordance with one or more aspects of the present disclosure. In some cases, the wireless communications system 200 may implement or be implemented by aspects of the wireless communications system 100. For example, the wireless communications system 200 may include one or more UEs 115 (e.g., a UE 115-a) and one or more network entities 105 (e.g., a network entity 105-a and a network entity 105-b), which may be examples of the corresponding devices as described herein.

The network entity 105-a may be associated with a cell 205-a and the network entity 105-b may be associated with a cell 205-b. At a given moment (e.g., as depicted in FIG. 2), the UE 115-a may be in communication with the cell 205-a and the cell 205-b. For example, the UE 115-a may be located within an overlapping service area corresponding to the cell 205-a and the cell 205-b. The UE 115-a may communicate with the network entity 105-a via an uplink communication link 210-a and a downlink communication link 215-a. Similarly, the UE 115-a may communicate with the network entity 105-b via an uplink communication link 210-b and a downlink communication link 215-b. The UE 115-a may support performing a PHO procedure to switch from communications with the cell 205-a to communications with the cell 205-b. Thus, the cell 205-a may be referred to as a source cell and the cell 205-b may be referred to as a target cell. In the following description, the term “transmit chain” (e.g., referred to as transmission chain, transmitter chain, radio frequency chain, or the like) may refer to a sequence of components, links, or media through which a device (e.g., a UE 115) may transmit one or more messages (e.g., an uplink connection 210). Similarly, the term “receive chain” (e.g., referred to as reception chain, receiver chain, radio frequency chain, or the like) may refer to a sequence of components, links, or media through which a device (e.g., a UE 115) may receive one or more messages (e.g., a downlink connection 215). Further, the term “transmit and receive chains” (e.g., Tx/Rx chains) may refer to a set of radio frequency chains, which may include one or more transmit chains, one or more receive chains, or a combination thereof.

The UE 115-a may support a PHO procedure with one or more enhancements. For example, the UE 115-a may transmit, via the uplink communication link 210-a, a capability message 220 that indicates a capability of the UE 115-a to perform a PHO procedure with multiple transmit and receive chains. In some implementations, the UE 115-a may transmit, via the uplink communication link 210-a, a message including preference information 225 associated with the UE 115-a (e.g., UE preference information). The preference information 225 may include a set of one or more indications associated with one or more communication parameters that may be desirable for communications at the UE 115-a (e.g., based on a location of the UE 115-a relative to a cell 205, or based on one or more measurement reports associated with transmit and receive chains or TRPs).

For example, the preference information 225 may include a first indication of a quantity of transmit and receive chains for the UE 115-a to communicate with a source cell (e.g., the cell 205-a), a quantity of transmit and receive chains for the UE 115-a to communicate with a target cell (e.g., the cell 205-b), or both. In some cases, the preference information 225 may include a second indication of a quantity of TRPs for the UE 115-a to communicate with the source cell, a quantity of TRPs for the UE 115-a to communicate with the target cell, or both. Additionally, or alternatively, the preference information 225 may include a third indication of a first subset of one or more particular TRPs for the UE 115-a to communicate with the source cell, a second subset of one or more particular TRPs for the UE 115-a to communicate with the target cell, or both.

The network entity 105-a may transmit, via the downlink communication link 215-a, a configuration message 230 that enables and configures a PHO procedure (e.g., an enhancement for the PHO procedure) with multiple transmit and receive chains. In some implementations, the network entity 105-a may transmit the configuration message 230 in response to (e.g., based on information in) the capability message 220, the preference information 225, or both. The configuration message 230 may indicate a quantity of transmit and receive chains for communicating with the source cell during a handover transition (e.g., to be used during the PHO procedure). Additionally, or alternatively, the configuration message 230 may indicate a quantity of transmit and receive chains for communicating with the target cell (e.g., the cell 205-b) during the handover transition. In some examples, the configuration message 230 may include an indication of a quantity of TRPs (or a particular set of one or more TRPs) for communicating with the source cell during the handover transition, a quantity of TRPs (or a particular set of one or more TRPs) for communicating with the target cell during the handover transition, or a combination thereof.

In some implementations, the configuration message 230 may configure a PHO procedure that supports a set of handover scenarios such as intra-frequence handover (e.g., handover where the UE 115-a remains on a same frequency or carrier), inter-frequency handover (e.g., handover where the UE 115-a switches to a different frequency or carrier), inter-radio access technology handover (e.g., handover where the UE 115-a switches between different releases associated with wireless communications), or any combination thereof. For example, the indicated quantities of transmit and receive chains, the indicated quantities of TRPs, and the indicated particular TRPs may apply for the one or more handover scenarios.

In some cases, the UE 115-a may receive one or more downlink messages 235 via the downlink communication link 215-a. For example, the UE 115-a may receive a handover command (e.g., a layer 1 or a layer 3 handover command), via a MAC-CE, a downlink control information (DCI) message, or RRC signaling. In some cases, the UE 115-a may support and may perform a CHO procedure that is associated with a condition. For example, the condition may be based on or associated with one or more factors, such as the UE 115-a moving in or out of a range associated with a cell 205 (e.g., the source cell or the target cell), the UE detecting that one or more measurement reports for transmit and receive chains or TRPs satisfies one or more thresholds, or a combination thereof.

In some implementations, the UE 115-a may perform a PHO procedure based on the configuration in response to receiving the handover command, in response to the condition (e.g., associated with the CHO procedure) being met, or both. Performing the PHO procedure may include performing a handover procedure while in communication with the source cell and the target cell according to one or more indications of the configuration message 230. For example, the UE 115-a may use a first subset of transmit and receive chains (e.g., partial transmit and receive chains) for serving cell communication (e.g., communications with the source cell) and a second subset of transmit and receive chains (e.g., partial transmit and receive chains) for performing one or more procedures associated with the target cell. The one or more procedures associated with the target cell may include a downlink search, a downlink synchronization procedure, a RACH procedure for uplink synchronization, or any combination thereof. In some cases, the UE 115-a may communicate with the source cell via a first set of one or more TRPs and may communicate with the target cell via a second set of one or more TRPs in accordance with the configuration message 230.

In some implementations, the UE 115-a may perform a channel state information (CSI) measurement procedure (e.g., generating a CSI measurement report) based on a subset of transmit and receive chains. In some cases, the UE 115-a may transmit a sounding reference signal (SRS) transmission that includes an indication of one or more CSI measurements resulting from the CSI measurement procedure (e.g., the CSI measurement report).

The network entity 105-a (e.g., the source cell) may perform a MIMO layer or a modulation and coding scheme (MCS) reduction procedure based on the capability message 220 (e.g., based on a UE PHO capability). Then, the network entity 105-a (e.g., the source cell) may transmit first scheduling information that indicates a lower MIMO layer and an MCS based on the capability message 220, the preference information 225, or both. In some implementations, the network entity 105-b (e.g., the target cell) may transmit one or more downlink messages 235 (e.g., via the downlink communication link 215-b) that include second scheduling information that indicates a second lower MIMO layer and a second MCS (e.g., based on a capability of the UE 115-a, preference information associated with the UE 115-a, or both). In some examples, the UE 115-a may receive the first scheduling information and the second scheduling information at a same time or at different times.

In some examples, the network entity 105-a may select one or more quantities of transmit and receive chains, and may transmit an indication of the one or more quantities to the UE 115-a. For example, the network entity 105-a may transmit a quantity of transmit and receive chains for communicating with the source cell, with one or more TRPs to be used during a handover transition. Similarly, the network entity 105-a may transmit a quantity of transmit and receive chains for communicating with the target cell, with one or multiple TRPs to be used during the handover transition.

In some implementations, the UE 115-a may perform a RACH procedure (e.g., with the target cell). The RACH procedure may be based on, in response to, or part of the PHO procedure. After completing the RACH procedure, the UE 115-a may use a full set of transmit and receive chains (e.g., all of the transmit and receive chains) for communicating with a new serving cell, such as the target cell (e.g., for multiple TRP communications). Accordingly, the UE 115-a may suspend communications with the previous serving cell (e.g., the source cell). In some examples, the UE 115-a may receive a packet data convergence protocol (PDCP) sequence number (SN). Then, the UE 115-a may transmit one or more uplink messages 240 via the uplink communication link 210-b. For example, the UE 115-a may transmit the received PDCP SN to the target cell (e.g., avoiding unnecessary data forwarding). In some cases, the network entity 105-b (e.g., the target cell) may forward data or may refrain from forwarding data based on the PDCP SN. In some cases, the techniques described herein may apply for layer 1 or layer 3 handover procedures, CHO procedures, sequence CHO procedures, or the like.

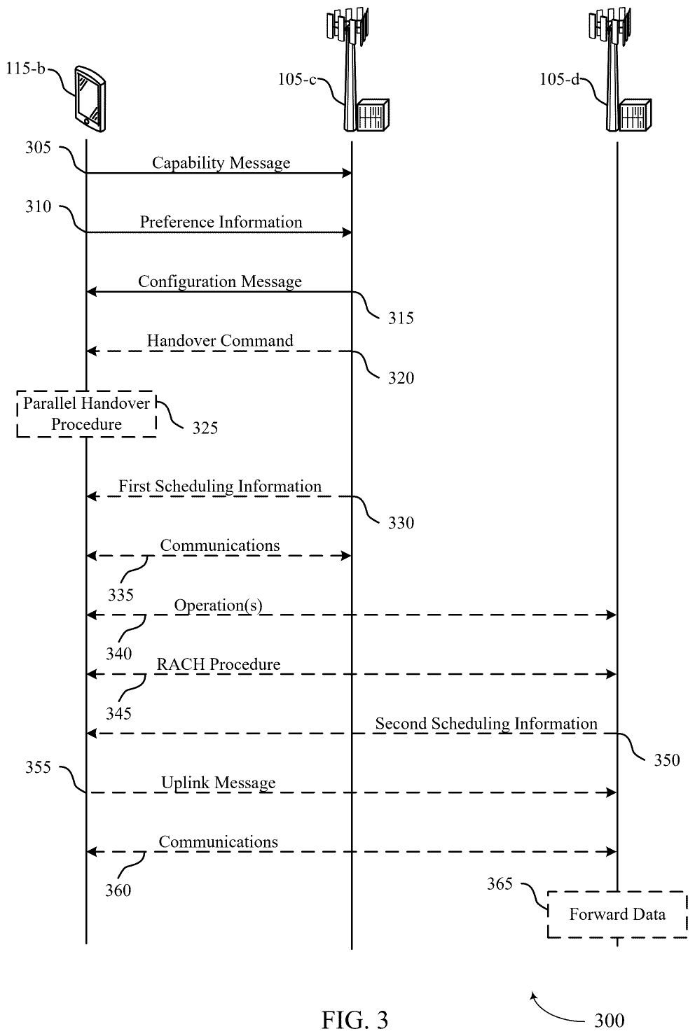

FIG. 3 shows an example of a process flow 300 that supports PHO with multiple transmission and reception chains in accordance with one or more aspects of the present disclosure. The process flow 300 includes a UE 115-b, a network entity 105-c, and a network entity 105-d, which may be examples of the corresponding devices as described with respect to FIGS. 1 and 2. In the following description of the process flow 300, the operations between the UE 115-b, the network entity 105-c, and the network entity 105-d may be performed in a different order than the example order shown. Some operations may also be omitted from the process flow 300, and other operations may be added to the process flow 300. Further, although some operations or signaling may be shown to occur at different times for discussion purposes, these operations may actually occur at the same time. The network entity 105-c may be referred to as a source cell and the network entity 105-d may be referred to as a target cell.

At 305, the UE 115-b may transmit a capability message indicating that the UE 115-b supports a PHO procedure. During the PHO procedure, the UE 115-b may be configured to communicate with both a source cell associated with the PHO procedure and a target cell associated with the PHO procedure using a set of transmit and receive chains of the UE 115-b.

At 310, the UE 115-b may transmit UE preference information associated with the PHO procedure. The UE preference information may indicate a respective quantity of transmit and receive chains corresponding to one or more TRPs associated with the PHO procedure, one or more respective TRPs corresponding to one or more cells associated with the PHO procedure, or both. The one or more cells may include one or both of the source cell and the target cell.

At 315, the UE 115-b may receive a configuration message that indicates a configuration for the PHO procedure. In some cases, the UE 115-b may receive the configuration message based on the capability message, the preference information, or both. In some examples, the configuration for the PHO procedure includes an indication of a condition associated with the PHO procedure. Performing the PHO procedure may be based on the condition being met.

At 320, the UE 115-b may receive a handover command (e.g., a layer 1 or a layer 3 handover command) associated with the parallel handover procedure. Performing the parallel handover procedure may be based on receiving the handover command. In some cases, the UE 115-b may receive the handover command via a MAC-CE, a DCI message, RRC signaling, or any combination thereof.

At 325, the UE 115-b may perform the PHO procedure in accordance with the configuration. In some examples, the UE 115-b may perform the PHO procedure while in communication with both the source cell and the target cell using the set of transmit and receive chains.

At 330, the UE 115-b may receive first scheduling information that is based on the capability message and the configuration for the PHO procedure. The first scheduling information may indicate an uplink or downlink lower MIMO layer and a corresponding MCS associated with communicating with the source cell. In some cases, the UE 115-b may receive the first scheduling information at a first time (e.g., t₀).

At 335, the UE 115-b may communicate with the source cell using a first subset of the set of transmit and receive chains. At 340, the UE 115-b may perform a set of one or more operations associated with the target cell using a second subset of the set of transmit and receive chains. In some cases, the second subset may be non-overlapping or overlapping with the first subset. The set of one or more operations includes a search associated with the target cell, a downlink synchronization procedure associated with the target cell, an uplink synchronization procedure associated with the target cell using a physical random access channel, or any combination thereof. The UE 115-b may perform the set of one or more operations using transmit and receive chains indicated by the configuration for the PHO procedure.

At 345, the UE 115-b may perform a RACH procedure to establish uplink synchronization with the target cell using transmit and receive chains indicated by the configuration for the PHO procedure. In some cases, the UE 115-b may perform the RACH procedure in accordance with the PHO procedure.

At 350, the UE 115-b may receive second scheduling information that is based on the capability message and the configuration for the PHO procedure. The second scheduling information may indicate a second uplink or downlink lower MIMO layer and a corresponding second MCS associated with communicating with the target cell. The UE 115-b may receive the second scheduling information using transmit and receive chains indicated by the configuration for the PHO procedure. In some cases, the UE 115-b may receive the second scheduling information from the target cell at a second time (e.g., t₁) In some examples, the first time and the second time may be a same time (e.g., t₀=t₁) or the first time and the second time may be different times (e.g., t₀≠t₁).

At 355, the UE 115-b may transmit an uplink message that includes a first indication that the PHO procedure is complete, a second indication of using the set (e.g., the full set) of transmit and receive chains to communicate with the target cell, a third indication of using a set of TRPs to communicate with the target cell, a fourth indication of a received PDCP SN, or any combination thereof. In some cases, one or more indications or parameters of the uplink message may be indicated via a MAC-CE, via an acknowledgment (e.g., an ACK) carried on a physical uplink control channel (PUCCH), via an acknowledgment that indicates that a PRACH procedure is complete, via RRC signaling, or any combination thereof.

At 360, the UE 115-b may suspend communications with the source cell based on a completion of the PHO procedure. Accordingly, the UE 115-b may communicate with the target cell based on the completion of the PHO procedure. In some cases, the UE 115-b may communicate with the target cell using a full set of transmit and receive chains corresponding to the set of transmit and receive chains.

At 365, the network entity 105-d (e.g., the target cell) may begin forwarding data based on the completion of the PHO procedure. In some cases, the network entity 105-d may begin forwarding the data based on the PDCP SN received from the UE 115-b.

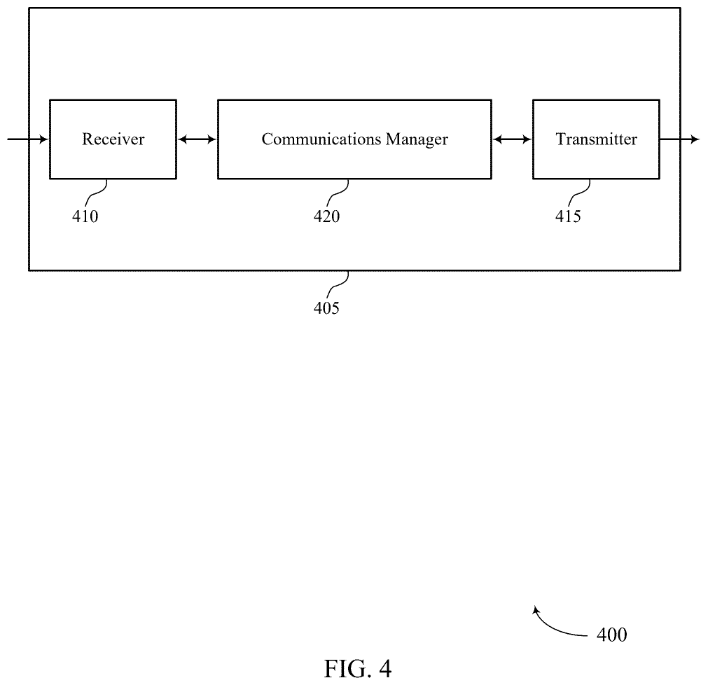

FIG. 4 shows a block diagram 400 of a device 405 that supports PHO with multiple transmission and reception chains in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to PHO with multiple transmission and reception chains). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to PHO with multiple transmission and reception chains). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of PHO with multiple transmission and reception chains as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for transmitting a capability message indicating that the UE supports a PHO procedure during which the UE is configured to communicate with both a source cell associated with the PHO procedure and a target cell associated with the PHO procedure using a set of multiple transmit and receive chains of the UE. The communications manager 420 is capable of, configured to, or operable to support a means for transmitting UE preference information associated with the PHO procedure, the UE preference information indicating a respective quantity of transmit and receive chains corresponding to one or more transmission and reception points associated with the PHO procedure, one or more respective transmission and reception points corresponding to one or more cells associated with the PHO procedure, or both, the one or more cells including one or both of the source cell and the target cell. The communications manager 420 is capable of, configured to, or operable to support a means for receiving, based on the capability message, a configuration message that indicates a configuration for the PHO procedure.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for PHO with multiple transmission and reception chains, which may result in reduced processing, reduced power consumption, more efficient utilization of communication resources, and improved candidate cell selection, among other advantages.

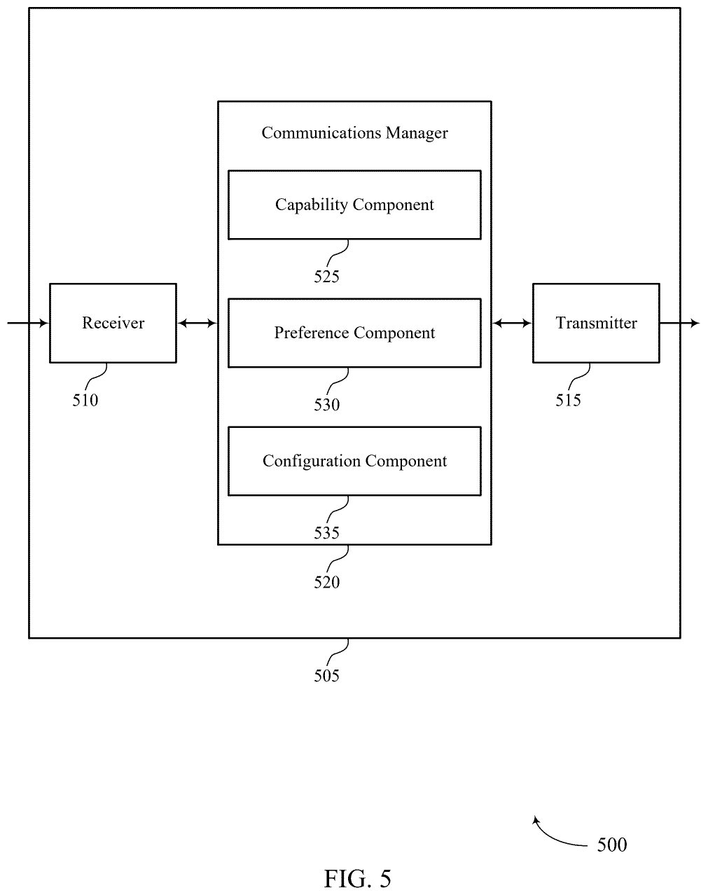

FIG. 5 shows a block diagram 500 of a device 505 that supports PHO with multiple transmission and reception chains in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to PHO with multiple transmission and reception chains). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to PHO with multiple transmission and reception chains). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of PHO with multiple transmission and reception chains as described herein. For example, the communications manager 520 may include a capability component 525, a preference component 530, a configuration component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The capability component 525 is capable of, configured to, or operable to support a means for transmitting a capability message indicating that the UE supports a PHO procedure during which the UE is configured to communicate with both a source cell associated with the PHO procedure and a target cell associated with the PHO procedure using a set of multiple transmit and receive chains of the UE. The preference component 530 is capable of, configured to, or operable to support a means for transmitting UE preference information associated with the PHO procedure, the UE preference information indicating a respective quantity of transmit and receive chains corresponding to one or more transmission and reception points associated with the PHO procedure, one or more respective transmission and reception points corresponding to one or more cells associated with the PHO procedure, or both, the one or more cells including one or both of the source cell and the target cell. The configuration component 535 is capable of, configured to, or operable to support a means for receiving, based on the capability message, a configuration message that indicates a configuration for the PHO procedure.

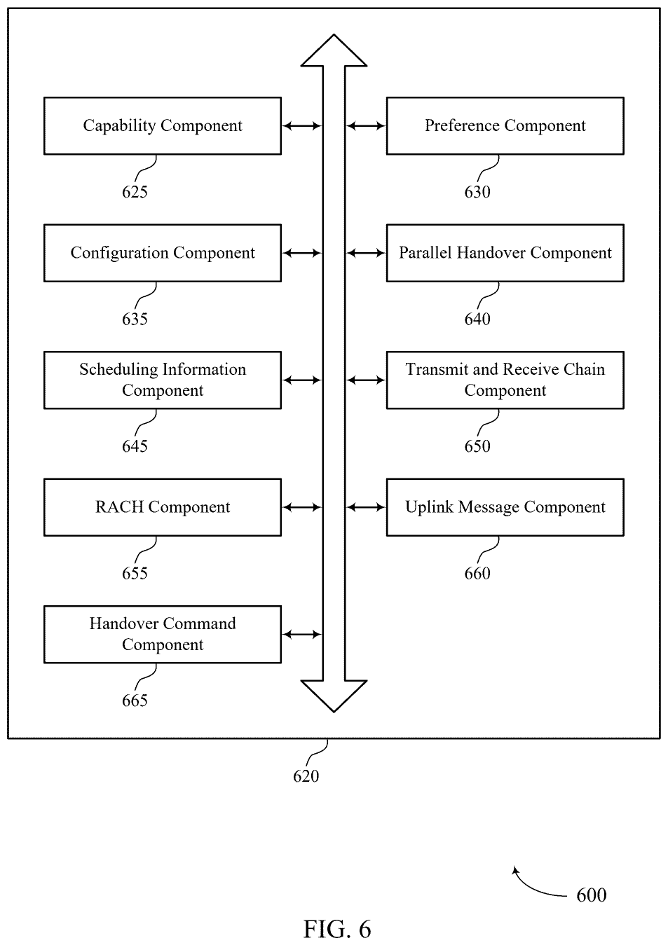

FIG. 6 shows a block diagram 600 of a communications manager 620 that supports parallel handover with multiple transmission and reception chains in accordance with one or more aspects of the present disclosure. The communications manager 620 may be an example of aspects of a communications manager 420, a communications manager 520, or both, as described herein. The communications manager 620, or various components thereof, may be an example of means for performing various aspects of parallel handover with multiple transmission and reception chains as described herein. For example, the communications manager 620 may include a capability component 625, a preference component 630, a configuration component 635, a PHO component 640, a transmit and receive chain component 645, a scheduling information component 650, a RACH component 655, an uplink message component 660, a handover command component 665, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The capability component 625 is capable of, configured to, or operable to support a means for transmitting a capability message indicating that the UE supports a parallel handover procedure during which the UE is configured to communicate with both a source cell associated with the parallel handover procedure and a target cell associated with the parallel handover procedure using a set of multiple transmit and receive chains of the UE. The preference component 630 is capable of, configured to, or operable to support a means for transmitting UE preference information associated with the parallel handover procedure, the UE preference information indicating a respective quantity of transmit and receive chains corresponding to one or more transmission and reception points associated with the parallel handover procedure, one or more respective transmission and reception points corresponding to one or more cells associated with the parallel handover procedure, or both, the one or more cells including one or both of the source cell and the target cell. The configuration component 635 is capable of, configured to, or operable to support a means for receiving, based on the capability message, a configuration message that indicates a configuration for the parallel handover procedure.

In some examples, the PHO component 640 is capable of, configured to, or operable to support a means for performing, while in communication with both the source cell and the target cell using the set of multiple transmit and receive chains, the parallel handover procedure in accordance with the configuration.

In some examples, the handover command component 665 is capable of, configured to, or operable to support a means for receiving a layer 1 or layer 3 handover command associated with the parallel handover procedure, where performing the parallel handover procedure is based on receiving the layer 1 or layer 3 handover command.

In some examples, the layer 1 or layer 3 handover command is received via a medium access control-control element, a downlink control information message, radio resource control signaling, or any combination thereof.

In some examples, the configuration for the parallel handover procedure includes an indication of a condition associated with the parallel handover procedure. In some examples, performing the parallel handover procedure is based on the condition being met.

In some examples, the transmit and receive chain component 645 is capable of, configured to, or operable to support a means for communicating with the source cell on a first frequency via a first RAT. In some examples, the transmit and receive chain component 645 is capable of, configured to, or operable to support a means for communicating with the target cell on a second frequency via a second RAT, where the first frequency and the second frequency include a same frequency or different frequencies, and where the first RAT and the second RAT include a same RAT or different RATs.

In some examples, the scheduling information component 650 is capable of, configured to, or operable to support a means for receiving first scheduling information that is based on the capability message and the configuration for the parallel handover procedure, the first scheduling information indicating an uplink or downlink lower multiple-input, multiple-output layer and a corresponding modulation and coding scheme associated with communicating with the source cell.

In some examples, the transmit and receive chain component 645 is capable of, configured to, or operable to support a means for communicating with the source cell using a first subset of the set of multiple transmit and receive chains. In some examples, the transmit and receive chain component 645 is capable of, configured to, or operable to support a means for performing a set of one or more operations associated with the target cell using a second subset of the set of multiple transmit and receive chains, the second subset non-overlapping or overlapping with the first subset.

In some examples, the set of one or more operations includes a search associated with the target cell, a downlink synchronization procedure associated with the target cell, an uplink synchronization procedure associated with the target cell using a physical random access channel, or any combination thereof. In some examples, the set of one or more operations are performed using transmit and receive chains indicated by the configuration for the parallel handover procedure.

In some examples, the RACH component 655 is capable of, configured to, or operable to support a means for performing, in accordance with the parallel handover procedure, a random access channel procedure to establish uplink synchronization with the target cell using transmit and receive chains indicated by the configuration for the parallel handover procedure.

In some examples, the scheduling information component 650 is capable of, configured to, or operable to support a means for receiving first scheduling information from the source cell at a first time. In some examples, the scheduling information component 650 is capable of, configured to, or operable to support a means for receiving second scheduling information from the target cell at a second time, where the first time and the second time include a same time or different times.

In some examples, the scheduling information component 650 is capable of, configured to, or operable to support a means for receiving second scheduling information that is based on the capability message and the configuration for the parallel handover procedure, the second scheduling information indicating a second uplink or downlink lower multiple-input, multiple-output layer and a corresponding second modulation and coding scheme associated with communicating with the target cell, where the second scheduling information is received using transmit and receive chains indicated by the configuration for the parallel handover procedure.

In some examples, the uplink message component 660 is capable of, configured to, or operable to support a means for transmitting an uplink message that includes a first indication that the parallel handover procedure is complete, a second indication of using the set of multiple transmit and receive chains to communicate with the target cell, a third indication of using a set of multiple transmission and reception points to communicate with the target cell, a fourth indication of a received packet data convergence protocol sequence number, or any combination thereof.

In some examples, one or more indications or parameters of the uplink message are indicated via a medium access control-control element, via an acknowledgment carried on a physical uplink control channel, via an acknowledgment that indicates that a physical random access channel procedure is complete, via radio resource control signaling, or any combination thereof.

In some examples, the transmit and receive chain component 645 is capable of, configured to, or operable to support a means for suspending communications with the source cell based on a completion of the parallel handover procedure. In some examples, the transmit and receive chain component 645 is capable of, configured to, or operable to support a means for communicating, based on the completion of the parallel handover procedure, with the target cell using a full set of transmit and receive chains corresponding to the set of multiple transmit and receive chains.

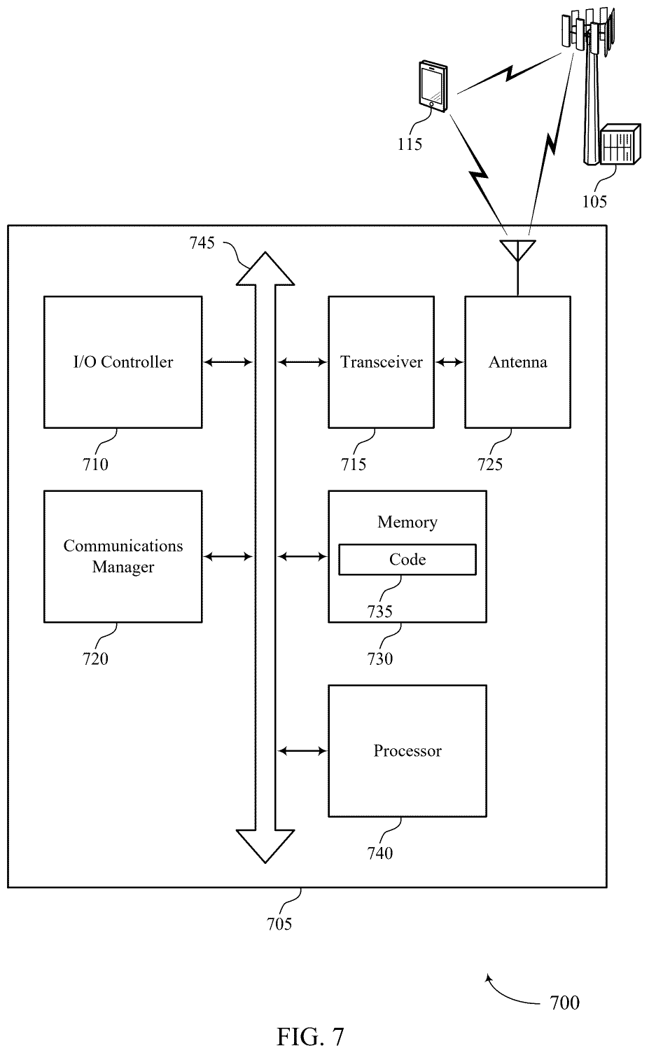

FIG. 7 shows a diagram of a system 700 including a device 705 that supports PHO with multiple transmission and reception chains in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting PHO with multiple transmission and reception chains). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for transmitting a capability message indicating that the UE supports a PHO procedure during which the UE is configured to communicate with both a source cell associated with the PHO procedure and a target cell associated with the PHO procedure using a set of multiple transmit and receive chains of the UE. The communications manager 720 is capable of, configured to, or operable to support a means for transmitting UE preference information associated with the PHO procedure, the UE preference information indicating a respective quantity of transmit and receive chains corresponding to one or more transmission and reception points associated with the PHO procedure, one or more respective transmission and reception points corresponding to one or more cells associated with the PHO procedure, or both, the one or more cells including one or both of the source cell and the target cell. The communications manager 720 is capable of, configured to, or operable to support a means for receiving, based on the capability message, a configuration message that indicates a configuration for the PHO procedure.

By including or configuring the communications manager 720 in accordance with examples as described herein, the device 705 may support techniques for PHO with multiple transmission and reception chains, which may result in improved communication reliability, reduced latency, improved user experience related to reduced processing, reduced power consumption, more efficient utilization of communication resources, improved utilization of processing capability, and improved candidate cell selection, among other advantages.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of PHO with multiple transmission and reception chains as described herein, or the at least one processor 740 and the at least one memory 730 may be otherwise configured to, individually or collectively, perform or support such operations.

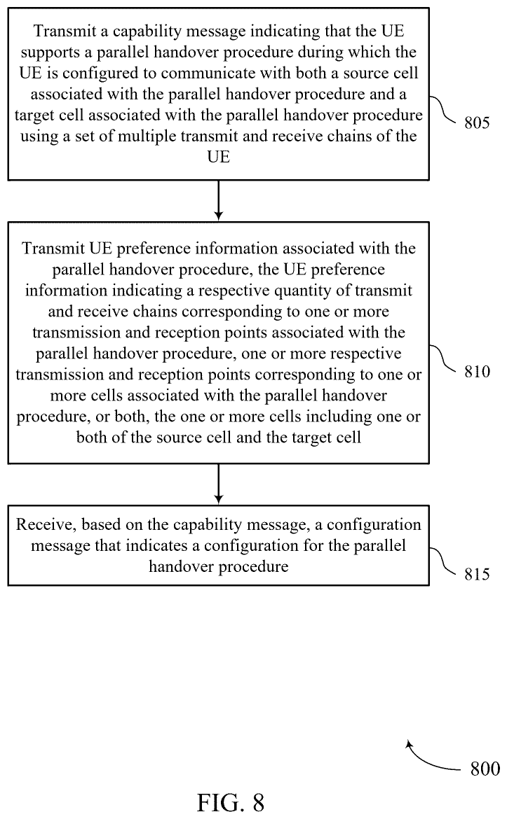

FIG. 8 shows a flowchart illustrating a method 800 that supports PHO with multiple transmission and reception chains in accordance with one or more aspects of the present disclosure. The operations of the method 800 may be implemented by a UE or its components as described herein. For example, the operations of the method 800 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 805, the method may include transmitting a capability message indicating that the UE supports a PHO procedure during which the UE is configured to communicate with both a source cell associated with the PHO procedure and a target cell associated with the PHO procedure using a set of multiple transmit and receive chains of the UE. The operations of 805 may be performed in accordance with examples as disclosed herein. In some examples, aspects of the operations of 805 may be performed by a capability component 625 as described with reference to FIG. 6.

At 810, the method may include transmitting UE preference information associated with the PHO procedure, the UE preference information indicating a respective quantity of transmit and receive chains corresponding to one or more transmission and reception points associated with the PHO procedure, one or more respective transmission and reception points corresponding to one or more cells associated with the PHO procedure, or both, the one or more cells including one or both of the source cell and the target cell. The operations of 810 may be performed in accordance with examples as disclosed herein. In some examples, aspects of the operations of 810 may be performed by a preference component 630 as described with reference to FIG. 6.

At 815, the method may include receiving, based on the capability message, a configuration message that indicates a configuration for the PHO procedure. The operations of 815 may be performed in accordance with examples as disclosed herein. In some examples, aspects of the operations of 815 may be performed by a configuration component 635 as described with reference to FIG. 6.

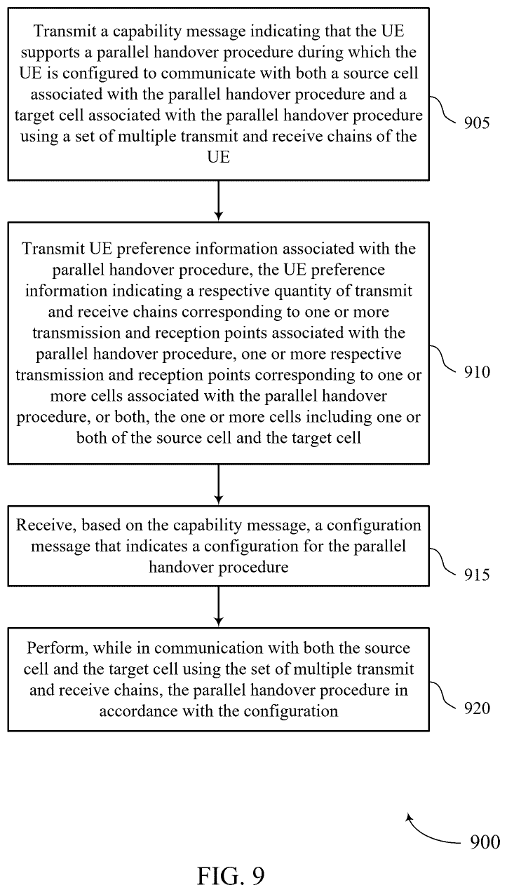

FIG. 9 shows a flowchart illustrating a method 900 that supports PHO with multiple transmission and reception chains in accordance with one or more aspects of the present disclosure. The operations of the method 900 may be implemented by a UE or its components as described herein. For example, the operations of the method 900 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 905, the method may include transmitting a capability message indicating that the UE supports a PHO procedure during which the UE is configured to communicate with both a source cell associated with the PHO procedure and a target cell associated with the PHO procedure using a set of multiple transmit and receive chains of the UE. The operations of 905 may be performed in accordance with examples as disclosed herein. In some examples, aspects of the operations of 905 may be performed by a capability component 625 as described with reference to FIG. 6.

At 910, the method may include transmitting UE preference information associated with the PHO procedure, the UE preference information indicating a respective quantity of transmit and receive chains corresponding to one or more transmission and reception points associated with the PHO procedure, one or more respective transmission and reception points corresponding to one or more cells associated with the PHO procedure, or both, the one or more cells including one or both of the source cell and the target cell. The operations of 910 may be performed in accordance with examples as disclosed herein. In some examples, aspects of the operations of 910 may be performed by a preference component 630 as described with reference to FIG. 6.

At 915, the method may include receiving, based on the capability message, a configuration message that indicates a configuration for the PHO procedure. The operations of 915 may be performed in accordance with examples as disclosed herein. In some examples, aspects of the operations of 915 may be performed by a configuration component 635 as described with reference to FIG. 6.

At 920, the method may include performing, while in communication with both the source cell and the target cell using the set of multiple transmit and receive chains, the PHO procedure in accordance with the configuration. The operations of 920 may be performed in accordance with examples as disclosed herein. In some examples, aspects of the operations of 920 may be performed by a PHO component 640 as described with reference to FIG. 6.

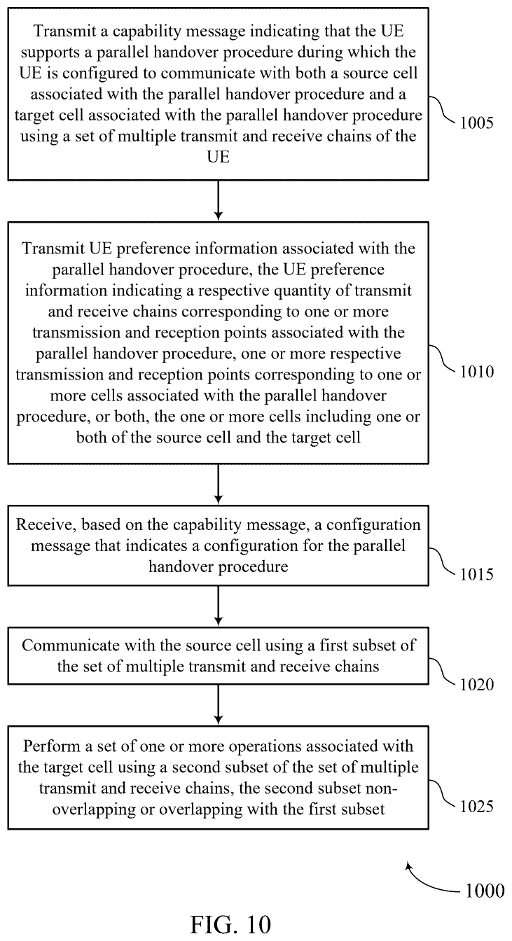

FIG. 10 shows a flowchart illustrating a method 1000 that supports PHO with multiple transmission and reception chains in accordance with one or more aspects of the present disclosure. The operations of the method 1000 may be implemented by a UE or its components as described herein. For example, the operations of the method 1000 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1005, the method may include transmitting a capability message indicating that the UE supports a PHO procedure during which the UE is configured to communicate with both a source cell associated with the PHO procedure and a target cell associated with the PHO procedure using a set of multiple transmit and receive chains of the UE. The operations of 1005 may be performed in accordance with examples as disclosed herein. In some examples, aspects of the operations of 1005 may be performed by a capability component 625 as described with reference to FIG. 6.

At 1010, the method may include transmitting UE preference information associated with the PHO procedure, the UE preference information indicating a respective quantity of transmit and receive chains corresponding to one or more transmission and reception points associated with the PHO procedure, one or more respective transmission and reception points corresponding to one or more cells associated with the PHO procedure, or both, the one or more cells including one or both of the source cell and the target cell. The operations of 1010 may be performed in accordance with examples as disclosed herein. In some examples, aspects of the operations of 1010 may be performed by a preference component 630 as described with reference to FIG. 6.

At 1015, the method may include receiving, based on the capability message, a configuration message that indicates a configuration for the PHO procedure. The operations of 1015 may be performed in accordance with examples as disclosed herein. In some examples, aspects of the operations of 1015 may be performed by a configuration component 635 as described with reference to FIG. 6.

At 1020, the method may include communicating with the source cell using a first subset of the set of multiple transmit and receive chains. The operations of 1020 may be performed in accordance with examples as disclosed herein. In some examples, aspects of the operations of 1020 may be performed by a transmit and receive chain component 645 as described with reference to FIG. 6.

At 1025, the method may include performing a set of one or more operations associated with the target cell using a second subset of the set of multiple transmit and receive chains, the second subset non-overlapping or overlapping with the first subset. The operations of 1025 may be performed in accordance with examples as disclosed herein. In some examples, aspects of the operations of 1025 may be performed by a transmit and receive chain component 645 as described with reference to FIG. 6.

The following provides an overview of aspects of the present disclosure:
Aspect 1: A method for wireless communications at a UE, comprising: transmitting a capability message indicating that the UE supports a PHO procedure during which the UE is configured to communicate with both a source cell associated with the PHO procedure and a target cell associated with the PHO procedure using a plurality of transmit and receive chains of the UE; transmitting UE preference information associated with the PHO procedure, the UE preference information indicating a respective quantity of transmit and receive chains corresponding to one or more TRPs associated with the PHO procedure, one or more respective TRPs corresponding to one or more cells associated with the PHO procedure, or both, the one or more cells comprising one or both of the source cell and the target cell; and receiving, based at least in part on the capability message, a configuration message that indicates a configuration for the PHO procedure.
Aspect 2: The method of aspect 1, further comprising: performing, while in communication with both the source cell and the target cell using the plurality of transmit and receive chains, the PHO procedure in accordance with the configuration.
Aspect 3: The method of aspect 2, further comprising: receiving a layer 1 or layer 3 handover command associated with the PHO procedure, wherein performing the PHO procedure is based at least in part on receiving the layer 1 or layer 3 handover command.
Aspect 4: The method of aspect 3, wherein the layer 1 or layer 3 handover command is received via a MAC-CE, a DCI message, RRC signaling, or any combination thereof.
Aspect 5: The method of any of aspects 2 through 4, wherein the configuration for the PHO procedure includes an indication of a condition associated with the PHO procedure, and performing the PHO procedure is based at least in part on the condition being met.
Aspect 6: The method of any of aspects 1 through 5, further comprising: communicating with the source cell on a first frequency via a first RAT; and communicating with the target cell on a second frequency via a second RAT, wherein the first frequency and the second frequency comprise a same frequency or different frequencies, and wherein the first RAT and the second RAT comprise a same RAT or different RATs.
Aspect 7: The method of any of aspects 1 through 6, further comprising: receiving first scheduling information that is based at least in part on the capability message and the configuration for the PHO procedure, the first scheduling information indicating an uplink or downlink lower MIMO layer and a corresponding MCS associated with communicating with the source cell.
Aspect 8: The method of any of aspects 1 through 7, further comprising: communicating with the source cell using a first subset of the plurality of transmit and receive chains; and performing a set of one or more operations associated with the target cell using a second subset of the plurality of transmit and receive chains, the second subset non-overlapping or overlapping with the first subset.
Aspect 9: The method of aspect 8, wherein the set of one or more operations comprises a search associated with the target cell, a downlink synchronization procedure associated with the target cell, an uplink synchronization procedure associated with the target cell using a PRACH, or any combination thereof, and the set of one or more operations are performed using transmit and receive chains indicated by the configuration for the PHO procedure.
Aspect 10: The method of any of aspects 1 through 9, further comprising: performing, in accordance with the PHO procedure, a random access channel procedure to establish uplink synchronization with the target cell using transmit and receive chains indicated by the configuration for the PHO procedure.
Aspect 11: The method of any of aspects 1 through 10, further comprising: receiving first scheduling information from the source cell at a first time; and receiving second scheduling information from the target cell at a second time, wherein the first time and the second time comprise a same time or different times.
Aspect 12: The method of any of aspects 1 through 11, further comprising: receiving second scheduling information that is based at least in part on the capability message and the configuration for the PHO procedure, the second scheduling information indicating a second uplink or downlink lower MIMO layer and a corresponding second MCS associated with communicating with the target cell, wherein the second scheduling information is received using transmit and receive chains indicated by the configuration for the PHO procedure.
Aspect 13: The method of any of aspects 1 through 12, further comprising: transmitting an uplink message that includes a first indication that the PHO procedure is complete, a second indication of using the plurality of transmit and receive chains to communicate with the target cell, a third indication of using a plurality of TRPs to communicate with the target cell, a fourth indication of a received packet data convergence protocol sequence number, or any combination thereof.
Aspect 14: The method of aspect 13, wherein one or more indications or parameters of the uplink message are indicated via a MAC-CE, via an acknowledgment carried on a PUCCH, via an acknowledgment that indicates that a PRACH procedure is complete, via RRC signaling, or any combination thereof.
Aspect 15: The method of any of aspects 1 through 14, further comprising: suspending communications with the source cell based at least in part on a completion of the PHO procedure; and communicating, based at least in part on the completion of the PHO procedure, with the target cell using a full set of transmit and receive chains corresponding to the plurality of transmit and receive chains.
Aspect 16: A UE for wireless communications, comprising one or more memories storing processor-executable code, and one or more processors coupled with the one or more memories and individually or collectively operable to execute the code to cause the UE to perform a method of any of aspects 1 through 15.
Aspect 17: A UE for wireless communications, comprising at least one means for performing a method of any of aspects 1 through 15.
Aspect 18: A non-transitory computer-readable medium storing code for wireless communications, the code comprising instructions executable by one or more processors to perform a method of any of aspects 1 through 15.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit a capability message indicating that the UE supports a parallel handover procedure during which the UE is configured to communicate with both a source cell associated with the parallel handover procedure and a target cell associated with the parallel handover procedure using a plurality of transmit and receive chains of the UE;
transmit UE preference information associated with the parallel handover procedure, the UE preference information indicating a respective quantity of transmit and receive chains corresponding to one or more transmission and reception points associated with the parallel handover procedure, one or more respective transmission and reception points corresponding to one or more cells associated with the parallel handover procedure, or both, the one or more cells comprising one or both of the source cell and the target cell; and
receive, based at least in part on the capability message, a configuration message that indicates a configuration for the parallel handover procedure.

2. The UE of claim 1, wherein the one or more processors are individually or collectively further operable to execute the code to cause the UE to:
perform, while in communication with both the source cell and the target cell using the plurality of transmit and receive chains, the parallel handover procedure in accordance with the configuration.

3. The UE of claim 2, wherein the one or more processors are individually or collectively further operable to execute the code to cause the UE to:
receive a layer 1 or layer 3 handover command associated with the parallel handover procedure, wherein performing the parallel handover procedure is based at least in part on receiving the layer 1 or layer 3 handover command.

4. The UE of claim 3, wherein the layer 1 or layer 3 handover command is received via a medium access control-control element, a downlink control information message, radio resource control signaling, or any combination thereof.

5. The UE of claim 2, wherein:
the configuration for the parallel handover procedure includes an indication of a condition associated with the parallel handover procedure, and
performing the parallel handover procedure is based at least in part on the condition being met.

6. The UE of claim 1, wherein the one or more processors are individually or collectively further operable to execute the code to cause the UE to:
communicate with the source cell on a first frequency via a first radio access technology (RAT); and
communicate with the target cell on a second frequency via a second RAT, wherein the first frequency and the second frequency comprise a same frequency or different frequencies, and wherein the first RAT and the second RAT comprise a same RAT or different RATs.

7. The UE of claim 1, wherein the one or more processors are individually or collectively further operable to execute the code to cause the UE to:
receive first scheduling information that is based at least in part on the capability message and the configuration for the parallel handover procedure, the first scheduling information indicating an uplink or downlink lower multiple-input, multiple-output layer and a corresponding modulation and coding scheme associated with communicating with the source cell.

8. The UE of claim 1, wherein the one or more processors are individually or collectively further operable to execute the code to cause the UE to:
communicate with the source cell using a first subset of the plurality of transmit and receive chains; and
perform a set of one or more operations associated with the target cell using a second subset of the plurality of transmit and receive chains, the second subset non-overlapping or overlapping with the first subset.

9. The UE of claim 8, wherein:
the set of one or more operations comprises a search associated with the target cell, a downlink synchronization procedure associated with the target cell, an uplink synchronization procedure associated with the target cell using a physical random access channel, or any combination thereof, and
the set of one or more operations are performed using transmit and receive chains indicated by the configuration for the parallel handover procedure.

10. The UE of claim 1, wherein the one or more processors are individually or collectively further operable to execute the code to cause the UE to:
perform, in accordance with the parallel handover procedure, a random access channel procedure to establish uplink synchronization with the target cell using transmit and receive chains indicated by the configuration for the parallel handover procedure.

11. The UE of claim 1, wherein the one or more processors are individually or collectively further operable to execute the code to cause the UE to:
receive first scheduling information from the source cell at a first time; and
receive second scheduling information from the target cell at a second time, wherein the first time and the second time comprise a same time or different times.

12. The UE of claim 1, wherein the one or more processors are individually or collectively further operable to execute the code to cause the UE to:
receive second scheduling information that is based at least in part on the capability message and the configuration for the parallel handover procedure, the second scheduling information indicating a second uplink or downlink lower multiple-input, multiple-output layer and a corresponding second modulation and coding scheme associated with communicating with the target cell, wherein the second scheduling information is received using transmit and receive chains indicated by the configuration for the parallel handover procedure.

13. The UE of claim 1, wherein the one or more processors are individually or collectively further operable to execute the code to cause the UE to:
transmit an uplink message that includes a first indication that the parallel handover procedure is complete, a second indication of using the plurality of transmit and receive chains to communicate with the target cell, a third indication of using a plurality of transmission and reception points to communicate with the target cell, a fourth indication of a received packet data convergence protocol sequence number, or any combination thereof.

14. The UE of claim 13, wherein one or more indications or parameters of the uplink message are indicated via a medium access control-control element, via an acknowledgment carried on a physical uplink control channel, via an acknowledgment that indicates that a physical random access channel procedure is complete, via radio resource control signaling, or any combination thereof.

15. The UE of claim 1, wherein the one or more processors are individually or collectively further operable to execute the code to cause the UE to:
suspend communications with the source cell based at least in part on a completion of the parallel handover procedure; and
communicate, based at least in part on the completion of the parallel handover procedure, with the target cell using a full set of transmit and receive chains corresponding to the plurality of transmit and receive chains.

16. A method for wireless communications at a user equipment (UE), comprising:
transmitting a capability message indicating that the UE supports a parallel handover procedure during which the UE is configured to communicate with both a source cell associated with the parallel handover procedure and a target cell associated with the parallel handover procedure using a plurality of transmit and receive chains of the UE;
transmitting UE preference information associated with the parallel handover procedure, the UE preference information indicating a respective quantity of transmit and receive chains corresponding to one or more transmission and reception points associated with the parallel handover procedure, one or more respective transmission and reception points corresponding to one or more cells associated with the parallel handover procedure, or both, the one or more cells comprising one or both of the source cell and the target cell; and
receiving, based at least in part on the capability message, a configuration message that indicates a configuration for the parallel handover procedure.

17. The method of claim 16, further comprising:
performing, while in communication with both the source cell and the target cell using the plurality of transmit and receive chains, the parallel handover procedure in accordance with the configuration.

18. The method of claim 16, further comprising:
communicating with the source cell using a first subset of the plurality of transmit and receive chains; and
performing a set of one or more operations associated with the target cell using a second subset of the plurality of transmit and receive chains, the second subset non-overlapping or overlapping with the first subset.

19. A non-transitory computer-readable medium storing code for wireless communications at a user equipment (UE), the code comprising instructions executable by one or more processors to:
transmit a capability message indicating that the UE supports a parallel handover procedure during which the UE is configured to communicate with both a source cell associated with the parallel handover procedure and a target cell associated with the parallel handover procedure using a plurality of transmit and receive chains of the UE;
transmit UE preference information associated with the parallel handover procedure, the UE preference information indicating a respective quantity of transmit and receive chains corresponding to one or more transmission and reception points associated with the parallel handover procedure, one or more respective transmission and reception points corresponding to one or more cells associated with the parallel handover procedure, or both, the one or more cells comprising one or both of the source cell and the target cell; and
receive, based at least in part on the capability message, a configuration message that indicates a configuration for the parallel handover procedure.

20. The non-transitory computer-readable medium of claim 19, wherein the instructions are further executable by the one or more processors to:
perform, while in communication with both the source cell and the target cell using the plurality of transmit and receive chains, the parallel handover procedure in accordance with the configuration.
